(19) United States
(12) Patent Application Publication
(10) Pub. No.: US 2025/0045656 A1
(43) Pub. Date: Feb. 6, 2025

(54) METHOD AND SYSTEM FOR CYBERSECURITY INCIDENT RESOLUTION

(71) Applicant: Cognitive Security Inc, Sault Ste Marie (CA)

(72) Inventors: Hassan KHAN, Waterloo (CA); Edward CROWDER, Sault Ste Marie (CA)

(73) Assignee: Cognitive Security Inc, Sault Ste Marie, ON (CA)

(21) Appl. No.: 18/791,731

(22) Filed: Aug. 1, 2024

Related U.S. Application Data
(60) Provisional application No. 63/516,939, filed on Aug. 1, 2023.

(51) Int. Cl. G06Q 10/0631; G06Q 10/0639

(52) U.S. Cl. CPC G06Q 10/063112; G06Q 10/06398

(57) ABSTRACT

A method comprises communicating training data to a computing device to in situ train a user on how to identify potential security incidents; tracking performance of the user based on the training data; and storing a profile of the user in a database, the profile indicating a level of performance of the user.

### CROSS-REFERENCE TO RELATED APPLICATIONS

This application claims priority to U.S. Provisional Patent Application No. 63/516,939, filed Aug. 1, 2023, the entire content of which is incorporated herein by reference.

### TECHNICAL FIELD

The present application relates to methods and systems for cybersecurity incident resolution.

### BACKGROUND

In the enterprise environment, the detection of security related incidents is often performed through rule or artificial intelligence (AI) based software. The software is used to detect a security threat and to forward the security threat to a security analyst at a Security Operation Center (SOC). The SOC may be associated with the enterprise or may be a third party.

The SOC may receive a large number of security threats and often prioritizes these security threads based on the incident type or the resource that is being attacked. One example of an incident type includes a brute force attack on passwords. One example of a resource that may be attacked includes an employee's laptop computer. Further, policy violating incidents such as for example malware and/or potentially unwanted programs (PUPs) often bypass current security solutions as there is nothing inherently malicious with the PUPs, yet the PUPS may break policy and/or governance. PUPs that break policy and/or governance may require review by the SOC which may be prone to delays and human error since analysts often have a large number of security threats to review. As such, security threats by way of PUPS may not be identified.

In the enterprise environment, an end user is often not involved with security incident resolution unless the SOC contacts the end user to understand the context of the security incident. Further, while end users may be trained to spot or identify email messages with malicious links from attackers, such as for example phishing emails, the end users are not trained or involved with the detection of more advanced security incidents such as for example flagging potentially malicious computer programs.

The end users are generally not involved with security incident resolution due to the lack of tools that provide information on security incidents and/or due to insufficient training. Further, users are often unwilling to allow monitoring software to be installed on their devices.

In some prior art systems, security incidents may be triaged and this may be done based on one or more elements such as for example the security incident time, the security incident type, and the resource being attacked. No information is provided by the end user, only from the computing device of the end user.

In some prior art systems, users are expected to watch security awareness training videos and/or are subject to testing through phishing emails. There are no systems in place that in situ trains the user after subjecting them to a security test.

### BRIEF DESCRIPTION OF THE DRAWINGS

Embodiments are described in detail below, with reference to the following drawings:

FIG. 1 is a high-level schematic diagram of an example computing device;

FIG. 2 shows a simplified organization of software components stored in a memory of the example computing device of FIG. 1;

FIG. 3 is a block diagram of the system according to an embodiment;

FIG. 4 is a block diagram of a storage module on a server side of the system of FIG. 3 according to an embodiment;

FIG. 5 is a block diagram of a module for anomaly detection forming part of the system of FIG. 3 according to an embodiment;

FIG. 6 is a block diagram of an analysis module forming part of the system of FIG. 3 according to an embodiment;

FIG. 7 is a block diagram of an enrichment module forming part of the system of FIG. 3 according to an embodiment;

FIG. 8 is a block diagram of a simulation module forming part of the system of FIG. 3 according to an embodiment;

FIG. 9 is a block diagram of a defanger module forming part of the system of FIG. 3 according to an embodiment;

FIG. 10 is a block diagram of an escalation module forming part of the system of FIG. 3 according to an embodiment; and

FIG. 11 is a flowchart of a method for performing an action on a potential security incident.

Like reference numerals are used in the drawings to denote like elements and features.

### DETAILED DESCRIPTION OF VARIOUS EMBODIMENTS

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, aspects of the disclosure transform a general-purpose computer into a special-purpose computing device when configured to execute the instructions described herein.

In the present application, various functionalities discussed herein may be performed by a single processor or by any one of one or more processors, either alone or in combination.

In one aspect there may be provided a method comprising communicating training data to a computing device to in situ train a user on how to identify potential security incidents; tracking performance of the user based on the training data, and storing a profile of the user in a database, the profile indicating a level of performance of the user.

In one or more embodiments, the method comprises receiving, from a computing device, an indication of a potential security incident; identifying a user of the computing device; retrieving the profile of the user from the database; and performing action on the potential security incident based on the profile of the user.

The action may include at least one of automatic quarantine, placing the potential security incident in a queue, degrading software associated with the potential security incident, halting communication with a server associated with the potential security incident, or blacklisting an IP address associated with the potential security incident.

In one or more embodiments, the security incident may be placed in a position of the queue based on the profile of the user.

In one or more embodiments, the security incident may be placed at a top position of the queue when the profile of the user indicates high performance of the user.

In one or more embodiments, the security incident may be placed at a top position of the queue when the profile of the user indicates low performance of the user.

In one or more embodiments, the method may include receiving, from another computing device, another indication of the potential security incident. and taking immediate action on the potential security incident.

In one or more embodiments, a method is provided for getting users to label and contextualize security related incident data about security related incidents that are generated from their computing devices.

In one or more embodiments, users are provided with software tools that communicate the security related incident data in an easy to understand format.

According to another aspect there is provided a system comprising at least one processor; a communications module, coupled to the at least one processor, for communicating with one or more computer networks; and a memory coupled to the at least one processor and storing instructions that, when executed by the at least one processor, cause the at least one processor to perform the aforementioned method.

According to another aspect there is provided a non-transitory computer-readable storage medium storing instructions that, when executed by at least one processor of a computer system, cause the computer system to perform the aforementioned method.

According to another aspect there is provided a method comprising analyzing computer statistics for one or more computer programs executing on a computing device; determining that at least one computer statistic for a particular computer program is abnormal; prompting a user of the computing device to submit details relating to the particular computer program; and sending information that includes the at least one computer statistic for the particular computer program and the details relating to the particular computer program to a server computer system for analysis.

In one or more embodiments, security incidents may be simulated on user computing devices and the user's performance on detecting the security incidents may be recorded. The simulation may be a result of executing a computer program or by modifying statistics on a dashboard or user interface that informs users about the programs currently running on their computing device and their behavior (such as for example the Windows™ Task Manager or MAC™ Activity Monitor). To accurately simulate the behavior, the system may use historical data obtained from a prior execution of a threat on a sandboxed machine.

In one or more embodiments, the users may be requested to label and contextualize security incident information when it is sent to a Security Operation Center (SOC). The security incident may be generated by an anomaly detection module of the system or by ingesting an alert from a Security Information and Event Management (SIEM) or other security product. At the SOC, the incidents get prioritized based on users' confidence in labeling and historic performance in addition to the currently used parameters.

In one or more embodiments, the users may receive in situ feedback on their performance on simulation tasks. For example, the user may be presented with a phishing email and may be prompted to label indicators (e.g. suspicious link, generic greeting) within the phishing email.

In one or more embodiments, the users may be required to mark the suspicious behavior of computer programs currently running or being executed on the computing device. For example, the user may be prompted to provide input in the form of free-form text to mark the suspicious behavior of a computer program. As another example, labels may be presented on a display screen of the computing device where each label may be dragged and dropped within a user interface that displays the phishing email or displays the computer program behavior. Other techniques may be used to mark the suspicious behavior. For example, the user may operate an input device such as for example a computer mouse to draw a line between the indicators/labels to the suspicious parts/behavior, may colour the indicators and related behavior with the same colour by clicking on their mouse or keyboard, or may choose the indicator and corresponding behavior. Other techniques may be used to enable matching indicators to suspicious aspects of email or program behavior.

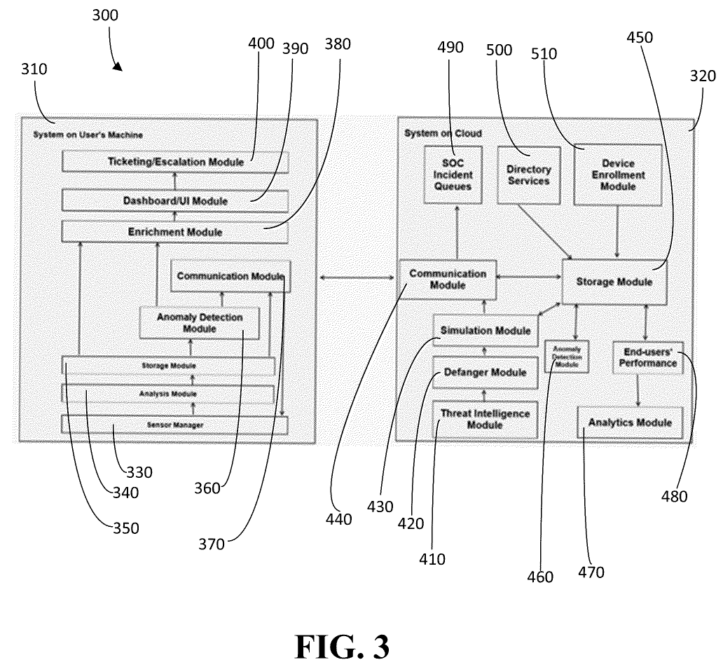

An example system 300 is shown in FIG. 3. As can be seen, the system includes a sub-system 310 resident on a computing device of a user and a sub-system 320 located in the cloud. The sub-system resident 310 on the computing device includes, among other features, a sensor manager 330, an analysis module 340, a storage module 350, an anomaly detection module 360, a communications module 370, an enrichment module 380, a dashboard/UI module 390, and a ticketing/escalation module 400. Details of the various modules are provided below.

The sensor manager 330 is generally responsible for collecting data from the operating system including but not limited to the applications, network connections, and startup programs.

The analysis module 340 analyzes the low-level sensor data and presents it in a higher dimension. For example, if a process or application has not been active, the analysis module may choose not to store the data from the process or the application.

The storage module 350 stores the collected data and may save any behavioral models of the user of the computing device.

The anomaly detection module 360 compares current sensor data with historical or past sensor data from the same user or from different users. In response to identifying a discrepancy between the current sensor data and the historical or past sensor data, an anomaly may be raised.

The communications module 370 is responsible for communication between the computing device and the cloud for data collection, escalation, and/or for running simulations.

The enrichment module 380 is responsible for enriching the collected data with insightful information. For example, instead of displaying the raw IP address that a host is communicating to, the enrichment module may inform the user that the host is communicating to another host that is under control by a particular organization or belongs to a country. The enrichment module 380 may additionally or alternatively enrich collected data with organization or department wide statistics. For example, the enrichment module 380 may inform the user how many other people in their organization or department are executing the same application or connecting to a target network host.

The dashboard/UI module 390 displays the anomalies and may provide a summary of all of the sensors. The user may operate the dashboard/UI module 390 to request additional details and in response, the additional details may be obtained and displayed.

The ticketing/escalation module 400 enables users to escalate an anomaly to the SOC or label a security alert as a false positive.

The sub-system located in the cloud includes, among other features, a threat intelligence module 410, a defanger module 420, a simulation module 430, a communications module 440, a storage module 450, an anomaly detection module 460, an analytics module 470, a user performance database 480, an SOC incident queue 490, a directory service 500 and a device enrollment module 510. Details of the various modules are provided below.

The threat intelligence module 410 tracks the latest threats and trends in cybersecurity for a particular domain/industry and possible attacks on a target organization.

The defanger module 420 is responsible for taking the properties of a security threat, received from the threat intelligence module, and generates a program with similar behavior but without negative side effects. For example, if a particular application reads user data and sends it to a server in a particular country, the defanger module 420 may generate another application that reads the same data of the user but sends random data to the same country but to a server that is controlled by the system.

The simulation module 430 is responsible for orchestrating the simulation of defanged malware for training purposes on computing devices and for collecting and storing performance results. The simulation module 430 may be performed by the execution of the defanger module 420 or by injecting the behavior into a user interface. For example, if the execution of the binary requires an outgoing connection to a suspicious country, the user interface may display the outgoing connection without initiating that connection.

In one or more embodiments, the system may demonstrate to the user how a cybersecurity threat will affect their computing device. The system may personalize a user's experience by simulating threat behavior on user interface elements displayed on a display screen of the computing device. For example, the system may demonstrate how a ransomware infection will unfold on the computing device by capturing the desktop background, the task windows and/or task bar from the computing device and overlaying the demonstration of the ransomware infection on top of the desktop background, the task windows and/or the task bar.

The communications module 440 is responsible for communication between the computing device and the cloud for data collection, escalation, and/or for running simulations.

The storage module 450 is responsible for storing the collected data, AI models, and profiles.

The anomaly detection module 460 is used to track and detect anomalies.

The analytics module 470 is responsible for generating analytics over the performance of the end users and providing those to the end users. Furthermore, since new threats often reuse techniques that were employed by previously seen threats (e.g., add itself to the registry for automated startup). This allows the system to predict users' performance on real threats that the users had never experienced before by calculating the performance on the overlapping techniques that they were trained and tested on before.

The user performance database 480 tracks the performance of users based on their interactions with simulated and real threats. The data tracked is used to later train the users or make appropriate decisions about escalating an issue.

The SOC incident queue 490 contains all the security alerts and the system provides a way to prioritize the security alerts.

The directory service 500 contains details of all of the users.

The device enrollment module 510 allows a target organization to add new end user devices or user computing devices to the system.

In one or more embodiments, a system and method are provided that allows users to operate a computing device to flag different types of potential security incidents as “to be investigated incidents.” The computing device may communicate the flagged incidents to a server computer system that may be associated with the SOC. The SOC may review the flagged incidents to prioritize incident resolution.

In one or more embodiments, the system may provide a graphical user interface that is to be displayed on a computing device and enables communication between the computing device and a server. The graphical user interface may present security incidents to the user in a format that may be readily understood by the user. In this manner, the user may be trained to identify or flag potential security incidents and/or to detect potentially malicious software. The performance of the user may be monitored and a profile may be built for the user. The profile may include the efficiency of the user at detecting different types of security threats.

In one or more embodiments, during normal device operation, if the user notices any behavior they have been trained to detect, the user may use the graphical user interface to label the security incident and/or to provide contextual information.

In one or more embodiments, the system may retrieve the historic performance of the user on incidents of a similar type and may include this information when forwarding the labeled incident to the SOC. For example, the system may maintain a database that stores information relating to the historic performance of the user and this information may be retrieved by the system. As the SOC, the historic performance of the user on similar incidents during training, the user's feedback, and other incident related properties may be used to triage the incident appropriately. In addition to helping with the triage of incidents, the data on the user's performance may also be used to build trust and confidence of the user over time.

The systems and methods described herein allow the user to be involved with security incident resolution. For example, the systems and methods may deploy a “Behaviour Explorer and Escalator” system that presents the program's behaviour to the users through an interface in a meaningful way that the users can comprehend. The behavioural activity of programs on the user's computing device may include, for example, CPU usage, disk usage, memory usage, network usage, network hosts communicated, files accessed and the type of access. Through use of the graphical user interface, the user can understand the behaviour of any program executing on their device.

The data that is collected and displayed to the user may be compared with the previous executions of the same program on the same computing device and on the computing devices of other users within the same organization. In one or more embodiments, if the behaviour of the program is similar to the previous executions on the same computing device or other computing devices, the behavior may be deemed acceptable and as such no security incident is detected. If, however, the behavior of the program is not similar to the previous executions on the same computing device or other computing devices threshold, for example if a process consumes more than a threshold amount of CPU, reads/writes a number of files on the disk, etc., then the program may be deemed potentially malicious.

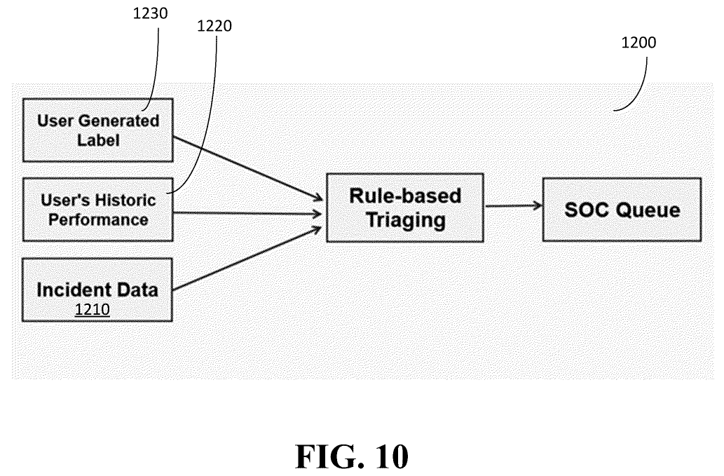

In one or more embodiments, for potentially malicious incidents, an alert is generated that requests the user to validate the behaviour. For example, the user may be presented with one or more options to label the potentially malicious incident as “potentially malicious” or “acceptable” and the user may be prompted to provide contextual information (e.g., a program downloaded from the web). This information may be sent to the SOC together with the incident type and incident data. At the SOC, incident data and user provided data are used for triaging the incident and this may be done using an escalation module 1200 (FIG. 10).

The escalation module may include incident data 1210 that is the data related to an incident which may be coming from an anomaly detector running on the end user machine or an alert received from the user when the user escalates some behaviour as potentially malicious.

The escalation module 1200 may track user's historic performance 1220 and this may be the past performance of users on alerts or incidents similar to the one that is currently being escalated.

The escalation module 1200 may include a user generated label 1230 that contains a user assigned binary label (malicious or non malicious) and any additional notes or details that user provided about the alert.

The escalation module may employ rule-based triaging. The rule-based triaging may determine or otherwise decide where the alert is to be positioned within the SOC queue. For example, the user's historic performance may be used to position the alert within the SOC queue. As one example, if a user known to have a high level of knowledge of security risks and threats assigned a malicious label then the alert may be prioritized and placed at the top of the SOC queue. As another example, if a user known to have a low level of knowledge of security risks and threats assigned a malicious label then the alert may not be as highly prioritized and may be placed in the middle or near the bottom of the SOC queue.

The rule-based triaging may include other types of rules. For example, if two users issue alerts that include a malicious label, then immediate action may be taken. The action that may be taken may include, automatic quarantine, degrading software associated with the alert, halting communication with a server hosting the threat, blacklisting one or more known IP addresses associated with the threat, etc.

At the SOC, once the incident/behaviour is investigated by a security analyst, the label is updated, and the behavioural history of the process and the accuracy of the user are logged into a database. In this manner, the behavioural history may be used to improve the flagging of potentially malicious behaviour.

The system may also store the labels and contextual information that is generated by users who are experts at the resolution of certain incident types (i.e., have performed accurately in incident classification). This information may be combined with the input from the security analyst and stored to provide hints or recommendations to other users who may see such alerts for a program in the same enterprise environment.

The system may also choose to label the users who are expert at correctly classifying a particular type of security incident as “security ambassadors.” The ambassadors may choose to assist other users who may require more training.

In one or more embodiments, the system may provide a “Behaviour Explorer and Escalator” for tracking the activity of current processes or programs running on a computing device, identifying new/abnormal behaviour, presenting the information to the user, and collecting feedback from the user.

In one or more embodiments, the system may include a program tracker module that uniquely identifies a computer process when it is executed (i.e., a particular video player being launched again is tagged to be the same process that was launched before);

In one or more embodiments, the system may include a sensor module that queries the computer processor to gather the statistics about the computer process, which include CPU usage, disk usage, memory usage, network usage, network hosts communicated, files accessed and the type of access, system configurations modified, network connections and the amount of data sent to each connection. In addition to per process, the sensor module may track the statistics system-wide and/or per network protocol.

In one or more embodiments, the system may include a compression module configured to compress the time series data from the storage module to a representation that enables efficient data storage without compromising the processing capability.

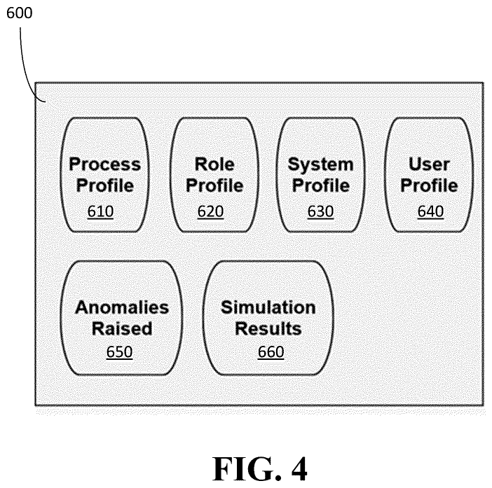

In one or more embodiments, the system may include a storage module 600 (FIG. 4) configured to store and retrieve the collected data in a database. The storage module 600 may be similar to or may include the storage module 350 and/or the storage module 450 described herein. The storage module 600 may maintain or otherwise store a process profile 610, a role profile 620, a system profile 630, a user profile 640, anomalies raised 650 and simulation results 660.

The process profile 610 stores the expected behavioral profile of each application/process.

The role profile 620 stores the expected behaviour of an average user for a particular role including but not limited to the processes/application that are executed and their behaviour, the hosts that it communicates to, the programs that are executed at the startup, the browser extensions.

The system profile 630 stores the profile of a particular target system in the environment. For example, different profiles would be associated for each role for a mobile system versus a desktop system.

The user profile 640 stores the profiles for all users.

The anomalies raised module 650 stores the anomalies that were flagged by the system for each user, which of those anomalies were escalated, and whether those anomalies were true positive or false positive.

The simulation results module 660 stores the results of simulating different threats against different target users.

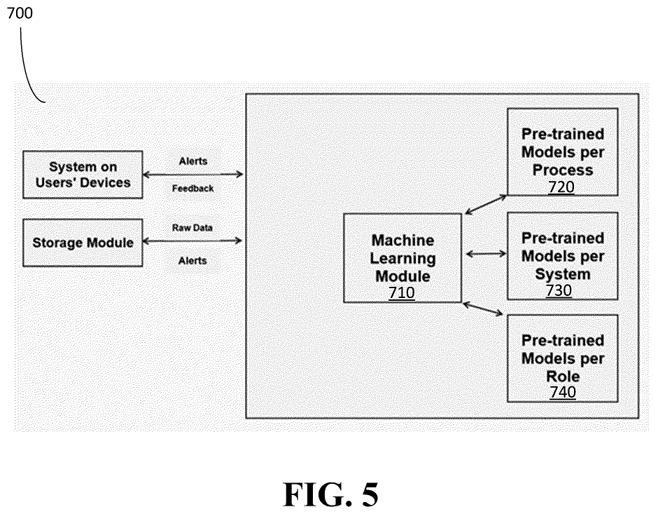

In one or more embodiments, the system may include an anomaly detection module 700 (FIG. 5). The anomaly detection module 700 may be similar to or may include the anomaly detection module 360 and/or the anomaly detection module 460 described herein. The anomaly detection module 700 may be configured to determine if the execution behaviour of the program is abnormal or new. If it is abnormal or new, the execution behavior of the program may be sent to the visualization system so that it can be presented to the user when the user is prompted to investigate abnormal behaviour.

The anomaly detection module may include a machine learning module 710 that is responsible for using AI/Machine Learning Techniques to detect anomalies.

The anomaly detection module 700 may include a pretrained models per process module 720 that store a classifier for each type of process that is able to take the execution behaviour of the process and is able to predict whether it is anomalous or not.

The anomaly detection module may include a pretrained models per system module 730 that store a classifier for each type of system that is able to take the execution behaviour of the whole system at a point in time and is able to predict whether it is anomalous or not.

The anomaly detection module may include a pretrained models per role module 740 that store a classifier for each type of role for each type of system that is able to take an the execution behaviour of the whole system and is able to predict whether it is anomalous or not.

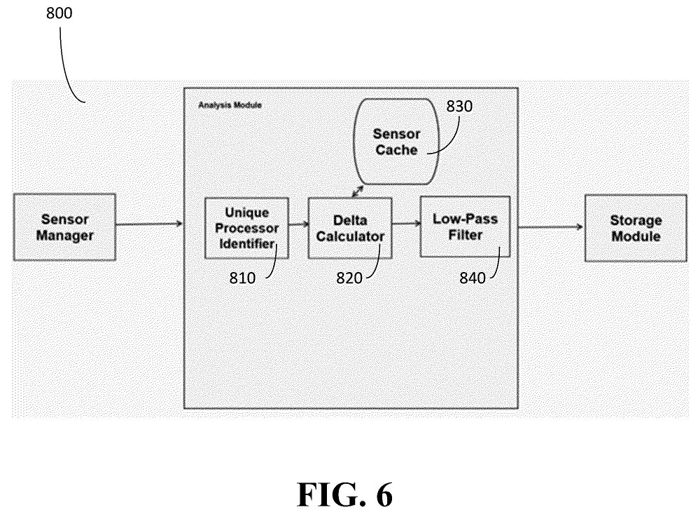

In one or more embodiments, the system may include an analysis module 800 (FIG. 6). The analysis module 800 may be similar to or may include the analysis module 340 described herein. The analysis module may obtain data from a sensor manager such as for example the sensor manager 330 described herein and may analyze computer statistics to identify abnormal or new behaviors.

The analysis module 800 may include a unique processor 810 identifier that tracks each unique process for different executions of that process. For web-based processes (i.e., browsers connecting to different websites/web services), it creates a unique identifier for the browser-destination pair.

The analysis module 800 may include a delta calculator 820 that is responsible for understanding how the behaviour of the process is changing over time.

The analysis module may include a sensor cache 830 that stores recently collected data from one or more sensors.

The analysis module may include a low-pass filter 840 that is responsible for ignoring values if there is no change in the process behaviour.

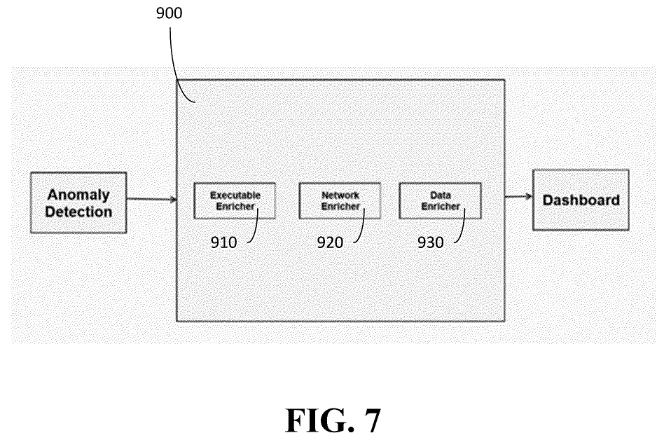

In one or more embodiments, the system may include an enrichment module 900 that may be used to enrich the collected data (FIG. 7). The enrichment module 900 may be similar to or may include the enrichment module 380 described herein. For example, the enrichment module 900 may query whether a particular IP address belongs to an abnormal entity and/or whether the cryptographic hash of an abnormal process is present in a malicious file database (such as VirusTotal), etc.

The enrichment module 900 may include an executable enricher 910 that adds several attributes to each process/application running on the machine including but not limited to a categorization of the process (e.g., productivity, game, etc). presence of the executable's hash in different malware databases.

The enrichment module 900 may include a network enricher 920 that adds details about the target host including the destination country, whether the IP address of the target host has been classified as malicious, what service usually runs on the port that it is communicating over.

The enrichment module 900 may include a data enricher 930 that is responsible for enriching files related information on the machine. It categorizes files as either belonging to or containing user data, operating system data, application data and so on.

In one or more embodiments, the system may include a visualization system that prioritizes abnormal or new behaviours and displays those to the user along with the enrichment from the threat intelligence module. The visualization system may additionally provide the user with an interface to label and/or provide a reason as to whether the detected anomaly was indeed an anomaly or whether it should be ignored. If the detected anomaly was indeed an anomaly, it may be optionally sent to the SOC for further review.

In one or more embodiments, the anomaly detection module may compare and provide a summary to the user on how their performance compares with other users in the department. For example, for users belonging to the DevOps group, the system may inform a particular user that an application was only executed on their computing device and not on any other user's computing device within the DevOps group.

In one or more embodiments, the system may include a communications module that sends the stored profiles for each process and the detected anomalies to the server. The communications module may additionally receive input from the server on whether a locally detected anomaly is indeed an anomaly and whether it should be displayed to the user by the visualization system. The communications module may communicate the user's label and rationale collected by the visualization module to the server;

In one or more embodiments, the system may include a simulator module that receives a process usage behaviour (i.e., CPU usage at 30% for 5 minutes, Disk IO of 100 MBs, and connect to a specific IP address) from the server and then spawns a process to emulate the same behaviour.

In one or more embodiments, the systems and methods may complement the systems executing on the computing device with a system for the global detection of anomalies.

In one or more embodiments, the system may include modules that run on a central server which may be located in the cloud. For example, the system may include a storage module that receives computer process statistics from all the computing devices in an organization and tags them appropriately for efficient lookups per process, per user, per department, and per role in the organization. The system may additionally include a global anomaly detection module that identifies abnormal execution behaviour in the context of appropriate department and appropriate role in the organization. The system may include a communication module that is responsible for receiving data from all of the computing devices and sending potential anomalies to the computing devices that are generated by the global anomaly detection module.

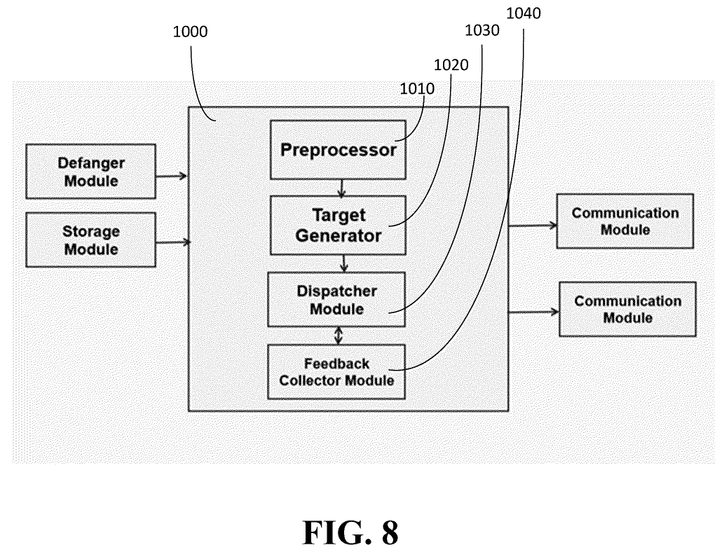

In one or more embodiments, there is provided a method to train the users to detect advanced threats. The system may provide administrators with running campaigns for security incident detection. The campaigns may simulate malicious behaviour on the user's computing devices. The system may include a simulation module 1000 (FIG. 8) that may be used for simulation. The simulation module 1000 may be similar to or may include the simulation module 430 described herein.

The simulation module may include a pre-processor 1010 that is responsible for taking the output from the defanger module.

The simulation module may include a target generator 1020 that iterates over the list of users and shortlists those users who will be targeted for this threat. This decision is made based on the historic performance of the user on similar threats or organization's policy.

The simulation module may include a dispatcher module 1030 that is responsible for deploying the threats on the end user computing devices or systems.

The simulation module may include a feedback collector module 1040 that waits for the feedback from the end user regarding their analysis of the simulated threat and stores it for analytics generation.

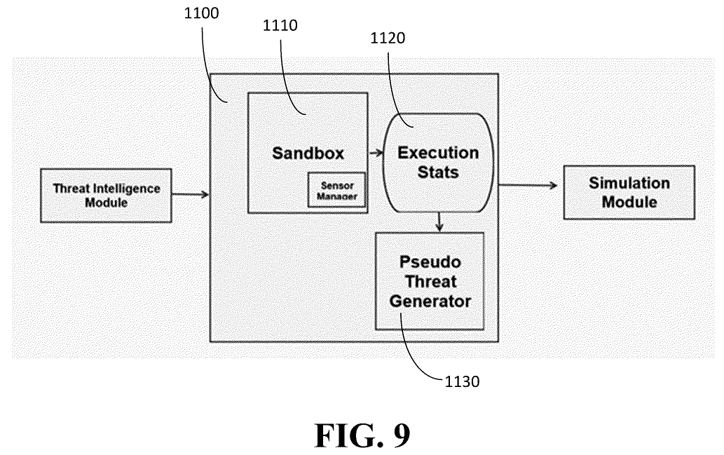

In one or more embodiments, the simulation module may require a defanger module 1100 (FIG. 9). The defanger module 1100 may include or may be similar to the defanger module 420 described herein. The defanger module 1100 takes the description of a threat or malware and generates a benign version of the threat or malware. The benign version provides similar properties in terms of behaviour (e.g., CPU usage, disk usage, files accessed, and network connections) without the malicious outcome. For example, if the malicious behaviour requires reading a sensitive file and sending data to a host located in a specific country, the benign version will read the same file and then send random data to a host under the control of the organization in the same country as the malicious host. In these embodiments, the method may take a malicious threat and may create a benign version of it, whose execution results in no harm to the computing device but provides similar properties as the malicious version.

The defanger module 1100 may include a sandbox 1110 that is responsible for taking a threat and running it in a safe environment to understand the behaviour of the threat.

The defanger module 1100 may include an execution stats module 1120 that reads the output from the sensor manager and the sandbox and feeds it to a pseudo threat generator.

The defanger module may include the pseudo threat generator 1130 that is responsible for generating a non-malicious version of the threat that the sandbox executed.

The training module may be used to prime the users by launching the defanged processes on the computing devices of the user. Additionally or alternatively, the system may present a dummy process with the same properties in the interface that it provides to the users without the actual execution of the program. The users are thus expected to identify the malicious behaviour using the behavioural cues, when prompted by the system. After inspecting the program, the user may label the program and may provide the rationale for their decision.

The performance of the users during training may be used to prioritize the programs that they later escalate as potentially malicious (i.e., programs that are not a part of the training but actual instances of malicious software) and for analytics for the security response time of the organization. For instance, it could be used to determine the time to detection for specific incidents by the department.

In one or more embodiments, the training module may set specific targets within an organization's departments. For instance, the organization may set the detection target for keystroke logger detection for their Software Engineers at 90%, and the system will automatically continue to train the department members who fail to meet that goal.

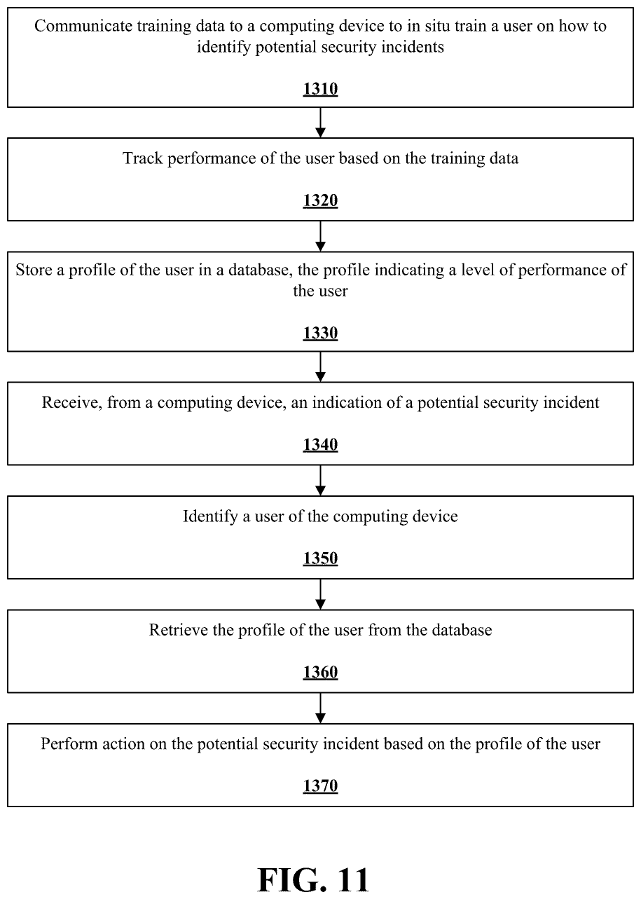

Reference is made to FIG. 11, which illustrates, in flowchart form, a method 1300 for performing an action on a potential security incident. The method 1300 may be implemented by a computing device having suitable processor-executable instructions for causing the computing device to carry out the described operations. As mentioned, the method 1300 may be implemented, in whole or in part, by one or more of the modules described herein.

The method 1300 includes communicating training data to a computing device to in situ train a user on how to identify potential security incidents (step 1310).

The training data may be generated based on historical data. The training data may be generated and communicated to the user in manners similar to that described herein. For example, the training data may be generated at least partially by the defanger module described herein.

The method 1300 includes tracking performance of the user based on the training data (step 1320).

The performance of the user may be tracked in manners similar to that described herein.

The method 1300 includes storing a profile of the user in a database, the profile indicating a level of performance of the user (step 1330).

The profile of the user may identify or assign a score to the user based on the level of performance of the user. The score may indicate a high, medium, or low performance of the user and this may be used to handle security incidents flagged by the user.

The method 1300 includes receiving, from a computing device, an indication of a potential security incident (step 1340).

The indication may be received in manners similar to that described herein.

The method 1300 includes identifying a user of the computing device (step 1350).

The user may be identified based on the computing device that sent the indication of the potential security incident. Other identifying information may be used such as an IP address, a username, etc.

The method 1300 includes retrieving the profile of the user from the database (step 1360).

The profile is retrieved based on the identification of the user and the level of performance of the user may be identified.

The method 1300 includes performing action on the potential security incident based on the profile of the user (step 1370).

The profile of the user may indicate that the user has, for example, a high, medium, or low knowledge of security.

The action may include at least one of automatic quarantine, placing the potential security incident in a queue, degrading software associated with the potential security incident, halting communication with a server associated with the potential security incident, or blacklisting an IP address associated with the potential security incident.

In one or more embodiments, the security incident may be placed in a position of the queue based on the profile of the user.

In one or more embodiments, the security incident may be placed at a top position of the queue when the profile of the user indicates high performance of the user.

In one or more embodiments, the security incident may be placed at a top position of the queue when the profile of the user indicates low performance of the user.

In one or more embodiments, the method may include receiving, from another computing device, another indication of the potential security incident. and taking immediate action on the potential security incident.

In manners described herein, the profile of a user may be utilized to determine actions to be taken to mitigate a potential security incident. For example, the profile may indicate that the user has a high knowledge of security risks and as such any potential security incident identified by the user may be mitigated immediately at an enterprise level and this may reduce overall reliance on computer and network resources to investigate and mitigate the security incident. As such, the potential security incident may be mitigated immediately (real-time or near real-time) and this may reduce the likelihood that the potential security incident cause problems within the enterprise.

The above-described methods and systems may be executed by one or more computing devices communicating over a computer network. In some embodiments, the network may be an internetwork such as may be formed of one or more interconnected computer networks. For example, the network may be or may include an Ethernet network, a wireless network, a telecommunications network, or the like.

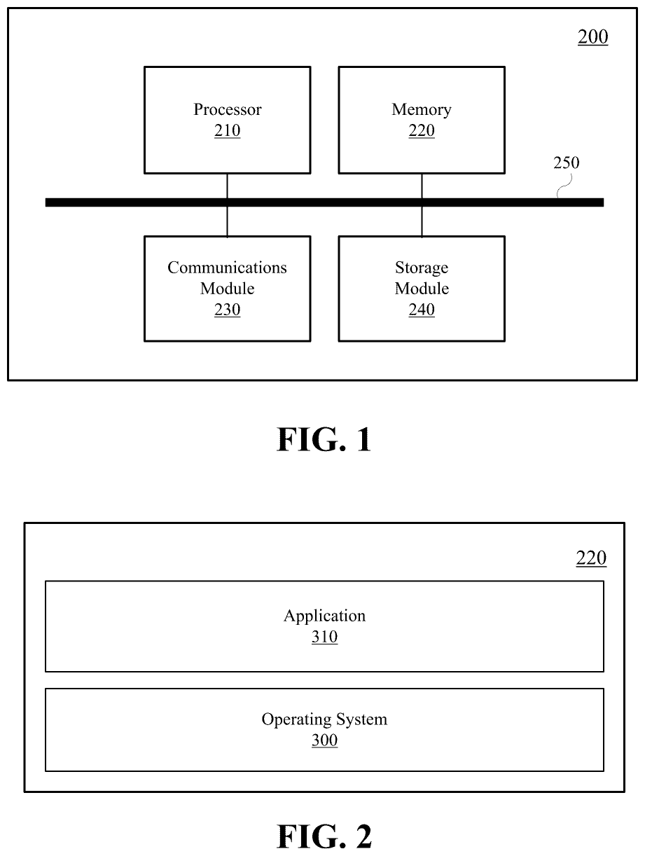

Referring now to FIG. 1, a high-level operation diagram of an example computing device 200 is shown. The example computing device 200 includes a variety of modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory processor-readable storage medium. A processor-readable medium may be organized using a file system such as may be administered by an operating system governing overall operation of the example computing device 200.

The communications module 230 allows the example computing device 200 to communicate with other computer or computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computing device 200 to communicate using near-field communication (NFC), via Wi-Fi™, using Bluetooth™ or via some combination of one or more networks or protocols. In some embodiments, all or a portion of the communications module 230 may be integrated into a component of the example computing device 200. For example, the communications module may be integrated into a communications chipset. In some embodiments, the communications module 230 may be omitted such as, for example, if sending and receiving communications is not required in a particular application.

The storage module 240 allows the example computing device 200 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a processor-readable medium. For example, software may be loaded into random-access memory from persistent storage of the memory 220. Additionally or alternatively, instructions may be executed by the processor 210 directly from read-only memory of the memory 220.

FIG. 2 depicts a simplified organization of software components stored in the memory 220 of the example computing device 200 (FIG. 1). As illustrated, these software components include an operating system 300 and an application 310.

The operating system 300 is software. The operating system 300 allows the application 310 to access the processor 210, the memory 220, and the communications module 230 of the example computing device 200 (FIG. 1). The operating system 300 may be, for example, Google™ Android™, Apple™ iOS™, UNIX™, Linux™, Microsoft™ Windows™, Apple OSX™ or the like.

The application 310 adapts the example computing device 200, in combination with the operating system 300, to operate as a device performing a particular function. While a single application 310 is illustrated in FIG. 2, in operation the memory 220 may include more than one application 310 and different applications 310 may perform different operations.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A method comprising:
communicating training data to a computing device to in situ train a user on how to identify potential security incidents;
tracking performance of the user based on the training data; and
storing a profile of the user in a database, the profile indicating a level of performance of the user.

2. The method of claim 1, further comprising:
receiving, from a computing device, an indication of a potential security incident;
identifying a user of the computing device;
retrieving the profile of the user from the database; and
performing action on the potential security incident based on the profile of the user.

3. The method of claim 2, wherein the action include at least one of automatic quarantine, placing the potential security incident in a queue, degrading software associated with the potential security incident, halting communication with a server associated with the potential security incident, or blacklisting an IP address associated with the potential security incident.

4. The method of claim 3, wherein the security incident is placed in a position of the queue based on the profile of the user.

5. The method of claim 3, wherein the security incident is placed at a top position of the queue when the profile of the user indicates high performance of the user.

6. The method of claim 3, wherein the security incident is placed at a top position of the queue when the profile of the user indicates low performance of the user.

7. The method of claim 2, further comprising:
receiving, from another computing device, another indication of the potential security incident; and
taking immediate action on the potential security incident.

8. A computer system comprising:
at least one processor;
a communications module, coupled to the at least one processor, for communicating with one or more computer networks; and
a memory coupled to the at least one processor and storing instructions that, when executed by the at least one processor, cause the at least one processor to:
communicate training data to a computing device to in situ train a user on how to identify potential security incidents;
track performance of the user based on the training data; and
store a profile of the user in a database, the profile indicating a level of performance of the user.

9. The computer system of claim 8, wherein the instructions, when executed, further cause the at least one processor to:
receive, from a computing device, an indication of a potential security incident;
identify a user of the computing device;
retrieve the profile of the user from the database; and
perform action on the potential security incident based on the profile of the user.

10. The system of claim 9, wherein the action include at least one of automatic quarantine, placing the potential security incident in a queue, degrading software associated with the potential security incident, halting communication with a server associated with the potential security incident, or blacklisting an IP address associated with the potential security incident.

11. The system of claim 10, wherein the security incident is placed in a position of the queue based on the profile of the user.

12. The system of claim 10, wherein the security incident is placed at a top position of the queue when the profile of the user indicates high performance of the user.

13. The system of claim 10, wherein the security incident is placed at a top position of the queue when the profile of the user indicates low performance of the user.

14. The system of claim 9, wherein the instructions, when executed, further cause the at least one processor to:
receive, from another computing device, another indication of the potential security incident; and
take immediate action on the potential security incident.

15. A non-transitory computer-readable storage medium storing instructions that, when executed by at least one processor of a computer system, cause the computer system to:
communicate training data to a computing device to in situ train a user on how to identify potential security incidents;
track performance of the user based on the training data; and
store a profile of the user in a database, the profile indicating a level of performance of the user.

16. The non-transitory computer-readable storage medium of claim 15, wherein the instructions, when executed by the at least one processor of the computer system, further cause the computer system to:
receive, from a computing device, an indication of a potential security incident;
identify a user of the computing device;
retrieve the profile of the user from the database; and
perform action on the potential security incident based on the profile of the user.
